(19) United States
(12) Patent Application Publication
(10) Pub. No.: US 2016/0198252 A1
(43) Pub. Date: Jul. 7, 2016

(54) EARPHONE ASSEMBLY AND TOUR GUIDE SYSTEM FOR TOURISTS

(71) Applicants: Fu Tai Hua Industry (Shenzhen) Co., Ltd., Shenzhen (CN); HON HAI PRECISION INDUSTRY CO., LTD., New Taipei (TW)

(72) Inventors: ZONG-YUAN SUN, New Taipei (TW); DA-HUA XIAO, Shenzhen (CN)

(21) Appl. No.: 14/735,845

(22) Filed: Jun. 10, 2015

(30) Foreign Application Priority Data
Jan. 5, 2015 (CN) 201510005977.7

(51) Int. Cl. H04R 1/10; G06K 7/10

(52) U.S. Cl. CPC H04R 1/1041; G06K 7/10425; H04R 1/1033; H04R 2201/103

(57) ABSTRACT

An earphone assembly includes a reader module and an audio interface unit. The reader module is in communication with a plurality of radio frequency identification (RFID) tags located at preselected locations. The reader module reads site identification number of the preselected locations from the plurality of RFID tags. The audio interface unit sends the site identification number of the preselected locations to the mobile terminal to control the mobile terminal to play locations introduction information of the preselected locations corresponding to the site identification number.

### FIELD

The subject matter herein generally relates to an earphone assembly and a tour guide system having radio frequency identification (RFID) tags to assist the tourists with tourist site introduction information at a current location.

### BACKGROUND

With the improvement of people's living standard, tourism has been developing vigorously. Group touring is a common method of vacationing. In such tours, the tour guide plans a certain journey at each stop, and thus a large group of people who usually don't know each other previously can travel from point to point.

### BRIEF DESCRIPTION OF THE DRAWINGS

Implementations of the present technology will now be described, by way of example only, with reference to the attached figure.

FIG. 1 is a block diagram of a tour guide system, according to a first exemplary embodiment.

FIG. 2 is a block diagram of a tour guide system, according to a second exemplary embodiment.

### DETAILED DESCRIPTION

Numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series and the like.

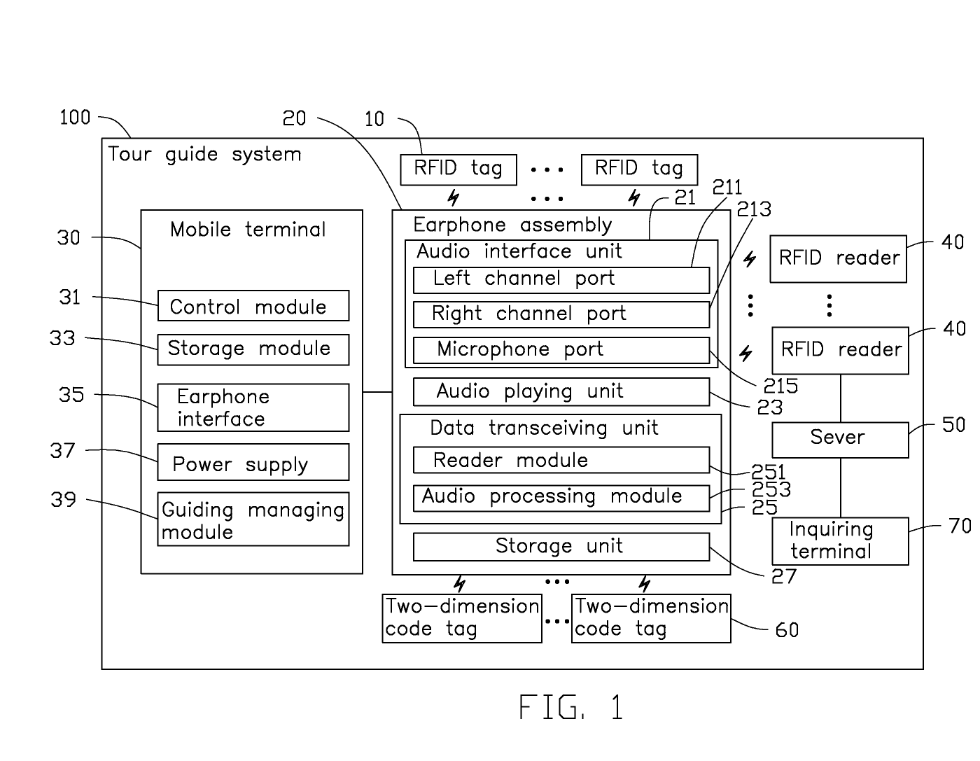

FIG. 1 illustrates a tour guide system 100, according to a first exemplary embodiment. The tour guide system 100 includes a plurality of radio frequency identification (RFID) tags 10, at least one earphone assembly 20, and at least one mobile terminal 30. In FIG. 1, only one earphone assembly 20 and one mobile terminal 30 are illustrated.

Each RFID tag 10 is located at a preselected location, for example, a tourist site. Each RFID tag 10 pre-stores a site identification number associated with the preselected locations and the site identification number can be identified by the earphone assembly 20.

The earphone assembly 20 reads the site identification number of the preselected locations from the RFID tag 10 and sends the site identification number to the mobile terminal 30. The mobile terminal 30 obtains locations introduction information according to the site identification number of the preselected locations and plays audio introduction information of the locations introduction information through the earphone assembly 20 and/or displays visual introduction information of the locations introduction information through a UI, such as a display, of the mobile terminal 30.

In this embodiment, the earphone assembly 20 is a wired earphone and includes an audio interface unit 21, an audio playing unit 23, a data transceiving unit 25, and a storage unit 27. The audio interface unit 21 is a wire-control audio transmission module. The audio interface unit 21 is electrically connected to the mobile terminal 30. The audio interface unit 21 is configured to obtain a power from the mobile terminal 30 and transmit data to or receive data from the mobile terminal 30.

The audio interface unit 21 includes a left channel port 211, a right channel port 213, and a microphone port 215. One of the left channel port 211 and the right channel port 213 is configured to receive a first audio signal with a specific frequency from the mobile terminal 30 to obtain working current for powering the audio playing unit 23 and the data transceiving unit 25. The other one of the left channel port 211 and the right channel port 213 is configured to receive a second audio signal for locations introduction from the mobile terminal 30 and transmit the second audio signal to the data transceiving unit 25. The microphone port 215 is configured to receive data from the data transceiving unit 25 and send the data to the mobile terminal 30.

The data transceiving unit 25 includes a reader module 251 and an audio processing module 253. The reader module 251 is configured to read the site identification number of the preselected locations from the RFID tag 10. In this embodiment, the site identification number is a binary digital signal. The audio processing module 253 converts an analog audio signal received by the audio interface unit 21 from the mobile terminal 30 into a binary digital signal and sends the binary digital signal to the reader module 251. In addition, the audio processing module 253 converts the binary digital signal from the reader module 251 into an analog audio signal and sends the analog audio signal to the mobile terminal 30 through the audio interface unit 21. Thus, audio introduction information of the locations introduction information corresponding to the site identification number of the preselected locations can be played through the earphone assembly 20 and/or visual introduction information of the locations introduction information can be displayed through a UI, such as a display, of the mobile terminal 30.

The storage unit 27 stores identification number information of each earphone assembly 20 and site identification number information of the preselected locations received by the earphone assembly 20.

The mobile terminal 30 can be a mobile phone and includes a control module 31, a storage module 33, an earphone interface 35, a power supply 37, and a guiding managing module 39. The control module 31 is configured to control the storage module 33, the earphone interface 35, the power supplying module 37, and the guiding managing module 39. The storage module 33 stores site identification number information of the preselected locations and the locations introduction information corresponding to the site identification number information of the preselected locations.

The earphone interface 35 is electrically connected to the earphone assembly 20. The earphone interface 35 is configured to receive the analog audio signal from the microphone interface 215 of the earphone assembly 20 and send the locations introduction information from the mobile terminal 30 to the earphone assembly 20 according to the received analog audio signal. The power supply 37 is configured to control the mobile terminal 30 to provide the first audio signal with a specific frequency and transmit the first audio signal with the specific frequency to the audio interference unit 21 through the earphone interface 35, thereby powering the audio playing unit 23, the data transceiving unit 25, and the storage unit 27.

The guiding managing module 39 is configured to provide a human-computer interaction interface. The guiding managing module 39 can output the locations introduction information automatically or according to a command input by the tourists. The guiding managing module 39 can further display an electronic guiding map. Then, the guiding managing module 39 can indicate a location of the mobile terminal 30 according to the site identification number information of the preselected locations obtained by the earphone assembly 20, which is facilitative for the tourist of the mobile terminal 30 to ensure the position at the locations.

In this embodiment, the power supply 37 and the guiding managing module 39 can both be stored in the storage module 33 in a form of application (APP) and are executed under a control of the control module 31. When the control module 31 receives the second audio signal which indicates the site identification number information of the locations, the control module 31 controls the storage module 33 to transmit the locations introduction information corresponding to the site identification number information of the locations to the earphone interface 21 and/or the guiding managing module 39, thereby playing and/or displaying the locations introduction information to the tourists.

In other embodiment, the tour guide system 100 further includes a plurality of RFID readers 40 and a sever 50. The plurality of RFID readers 40 are dispersedly located at the preselected locations and communicate with the server 50. In this embodiment, the plurality of RFID readers 40 are communicated with the server 50 via a fiber optic network or a serial port.

The sever 50 stores site identification number of the preselected locations, locations introduction information, and an installation package of the APPS of the power supply 37 and the guiding managing module 39. Then, the mobile terminal 30 of the tourist can preset download and store the site identification number of the preselected locations and the locations introduction information from the sever 50. The locations introduction information corresponds to the site identification number of the preselected locations.

Further, the server 50 is configured to record a total amount of the tourists at the preselected locations and feedbacks the total amount of the tourists to the mobile terminal 30. In detail, each RFID reader 40 has a radiation radius. The RFID reader 40 obtains the identification number information of each earphone assembly 20 which is in the radiation radius of the RFID reader 40 and outputs the identification number information of the earphone assembly 20 to the server 50. Then, the server 50 records a total amount of the tourists at the preselected locations according to the received site identification number information of the earphone assembly 20 and feedbacks the total amount of the tourists to the mobile terminal 30.

In at least one embodiment, all of the RFID tag 10, the reader module 251 of the data transceiving unit 25, and the RFID reader 40 can operate at about 2.4 GHz. In detail, the RFID tag 10 can be an active tag and both the reader module 251 of the data transceiving unit 25 and the RFID reader 40 can be active readers.

Further, in other embodiments, the tour guide system 100 also includes a plurality of two-dimension code tags 60. The plurality of two-dimension code tags 60 are located at the preselected locations, and each two-dimension code tag 60 stores two-dimension code information indicating a location of the two-dimension code tag 60. The two-dimension code tag 60 can be scanned by the mobile terminal 30. Thus, the mobile terminal 30 can obtain the two-dimension code information and send the two-dimension code information to the server 50. At this time, the server 50 can record a total amount of the tourists at the preselected locations, and then the server 50 sends a feedback signal indicating the total amount of the tourists at the preselected locations to the mobile terminal 30 to facilitate tour schedule of the tourists to save time. In at least one time, the mobile terminal 30 communicates with the server 50 via a cellular network or a WIFI network.

Further, in other embodiments, the tour guide system 100 also includes a plurality of inquiring terminals 70. The inquiring terminals 70 are positioned at preselected locations and are electrically connected to the server 50. The inquiring terminals 70 are configured to inquire locations introduction information according to the site identification number information input by the tourists.

In use, when the tourists taking the earphone assembly 20 and the mobile terminal 30 enters the preselected locations, the reader module 251 of the earphone assembly 20 reads the site identification number of the preselected locations from the RFID tag 10, the audio process module 253 processes the site identification number and sends the processed site identification number of the preselected locations to the mobile terminal 30. An audio introduction information of the locations introduction information corresponding to the site identification number of the preselected locations can be played through the earphone assembly 20 and/or a visual introduction information of the locations introduction information can be displayed through a UI, such as a display, of the mobile terminal 30

In addition, when the earphone assembly 20 enters the radiation radius of the RFID reader 40, the RFID reader 40 can obtain the identification number information of the earphone assembly 20 via wireless communication and output the identification number information of the earphone assembly 20 to the server 50. At this time, the server 50 records a total amount of the tourists at the preselected locations according to the identification number information of the earphone assembly 20 and feedbacks the total amount of the tourists to the mobile terminal 30.

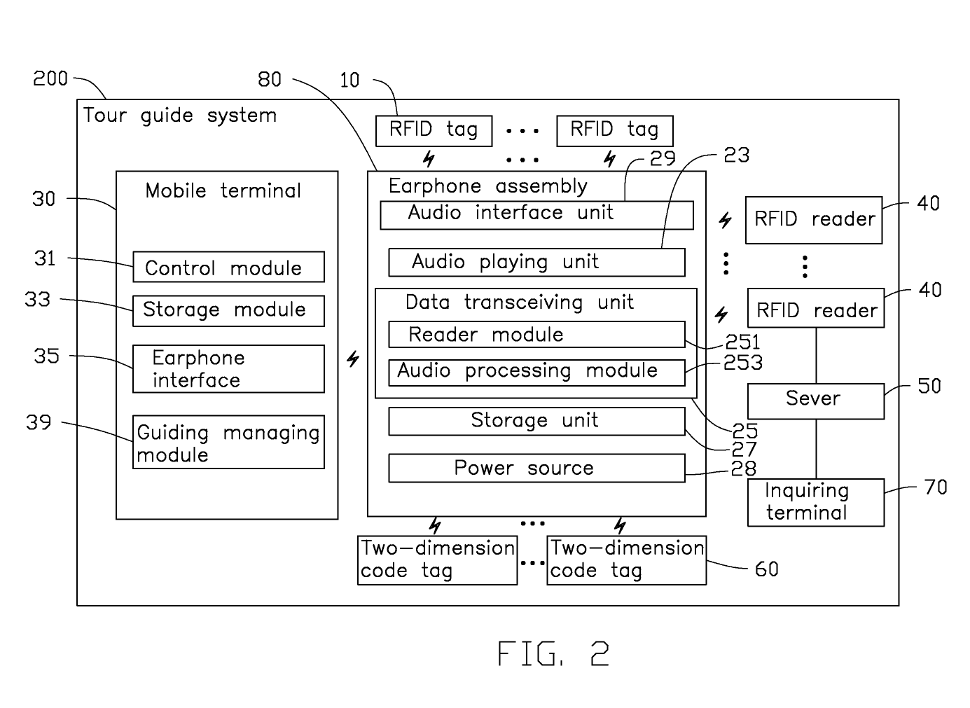

FIG. 2 illustrates a tour guide system 200, according to a second exemplary embodiment. The tour guide system 200 differs from the tour guide system 100 that the earphone assembly 80 is a BLUETOOTH® earphone assembly. The earphone assembly 80 includes the audio playing unit 23, the data transceiving unit 25, the storage unit 27, a power source 28, and an audio interface unit 29. The audio interface unit 29 is a BLUETOOTH® unit and the data transceiving unit 25 is communicated with the mobile terminal 30 through the audio interface unit 29. The power source 28 can be a rechargeable battery and is configured to provide power to the audio interface unit 29, the audio playing unit 23, and the data transceiving unit 25. Optionally, the power supply 37 of the mobile terminal 30 can be omitted.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An earphone assembly comprising:
a reader module in signal communication with a plurality of radio frequency identification (RFID) tags located at preselected locations, the reader module configured to read site identification number of the preselected locations from the plurality of RFID tags; and
an audio interface unit configured to send the site identification number of the preselected locations to the mobile terminal to control the mobile terminal to play locations introduction information of the preselected locations corresponding to the site identification number.

2. The earphone assembly of claim 1, wherein the audio interface unit is a wire-control audio transmission module and comprises a left channel port, a right channel port, and a microphone port; the earphone assembly obtains power from the mobile terminal through one of the left channel port and the right channel port, receives an audio signal for locations introduction from the mobile terminal through the other one of the left channel port and the right channel port, and sends the site identification number of the preselected locations to the mobile terminal through the microphone port.

3. The earphone assembly of claim 1, further comprising an audio processing module, wherein the audio processing module converts an analog audio signal received by the audio interface unit from the mobile terminal into a binary digital signal and sends the binary digital signal to the reader module, the audio processing module further converts a binary digital signal from the reader module into an analog audio signal and sends the analog audio signal to the mobile terminal through the audio interface unit.

4. The earphone assembly of claim 3, wherein the audio interface unit is a BLUETOOTH® unit, and the audio processing module is in communication with the mobile terminal through the BLUETOOTH® unit.

5. The earphone assembly of claim 4, further comprising a power supply for powering the audio interface unit, the reader module, and the audio processing module.

6. The earphone assembly of claim 1, further comprising a storage unit for storing the site identification number of the preselected locations from the plurality of RFID tags and identification number information of the earphone assembly.

7. The earphone assembly of claim 1, further comprising an audio playing unit for playing the locations introduction information of the preselected locations from the mobile terminal.

8. A tour guide system comprising:
a plurality of radio frequency identification (RFID) tags located at preselected locations, each RFID tag pre-storing a site identification number of the preselected locations;
a mobile terminal storing and output locations introduction information correlated with the site identification numbers from the RFID tags; and
an earphone assembly comprising:
a reader module in communication with the plurality of radio frequency identification (RFID) tags and reading the site identification number of the preselected locations from the plurality of RFID tags; and
an audio interface unit sending the site identification number of the preselected locations to the mobile terminal to direct the mobile terminal to output locations introduction information of the preselected locations corresponding to the site identification number.

9. The tour guide system of claim 8, wherein the audio interface unit is a wire-control audio transmission module and comprises a left channel port, a right channel port, and a microphone port; the earphone assembly obtains power from the mobile terminal through one of the left channel port and the right channel port, receives an audio signal for locations introduction from the mobile terminal through the other one of the left channel port and the right channel port, and sends the site identification number of the preselected locations to the mobile terminal through the microphone port.

10. The tour guide system of claim 8, further comprising an audio processing module, wherein the audio processing module converts an analog audio signal received by the audio interface unit from the mobile terminal into a binary digital signal and sends the binary digital signal to the reader module, the audio processing module further converts a binary digital signal from the reader module into an analog audio signal and sends the analog audio signal to the mobile terminal through the audio interface unit.

11. The tour guide system of claim 10, wherein the audio interface unit is a BLUETOOTH® unit, and the audio processing module is in communication with the mobile terminal through the BLUETOOTH® unit.

12. The tour guide system of claim 11, further comprising a power supply for powering the audio interface unit, the reader module, and the audio processing module.

13. The tour guide system of claim 8, further comprising a storage unit for storing the site identification number of the preselected locations from the plurality of RFID tags and identification number information of the earphone assembly.

14. The tour guide system of claim 8, further comprising an audio playing unit for playing or displaying the locations introduction information of the preselected locations from the mobile terminal.

15. The tour guide system of claim 8, further comprising a server, wherein the server stores site identification number of the preselected locations and locations introduction information, the mobile terminal downloads and stores the site identification number of the preselected locations and the locations introduction information from the sever.

16. The tour guide system of claim 15, further comprising a plurality of RFID readers, wherein the RFID readers are dispersedly located at the preselected locations and are in communication with the server, the RFID reader obtains the identification number information of each earphone assembly which is in the radiation radius of the RFID reader and outputs the identification number information of the earphone assembly to the server; the server records a total amount of the tourists at the preselected locations according to the received identification number information of the earphone assembly and feedbacks the total amount of the tourists to the mobile terminal.

17. The tour guide system of claim 15, further comprising a plurality of two-dimension code tags located at the preselected locations, wherein each two-dimension code tag stores two-dimension code information indicating a location of the two-dimension code tag; the mobile terminal obtains the two-dimension code information and sends the two-dimension code information to the server, and the server records a total amount of the tourists at the preselected locations and sends a feedback signal indicating the total amount of the tourists at the preselected locations to the mobile terminal.

18. The tour guide system of claim 15, further comprising a plurality of inquiring terminals, wherein the inquiring terminals are positioned at preselected locations and are electrically connected to the server, the inquiring terminals are configured to inquire locations introduction information according to the site identification number information input by the tourists.
